(19) United States
(12) Patent Application Publication
(10) Pub. No.: US 2026/0000035 A1
(43) Pub. Date: Jan. 1, 2026

(54) Sprinkler Indicator Tag And Related Methods

(71) Applicant: Rain Bird Corporation, Azusa, CA (US)

(72) Inventors: Suzanne Marie Schneider, Corona de Tucson, AZ (US); Jeffrey Glenn Johnson, Oro Valley, AZ (US)

(21) Appl. No.: 18/754,514

(22) Filed: Jun. 26, 2024

(51) Int. Cl. A01G 25/02; B05B 15/14

(52) U.S. Cl. CPC A01G 25/02; B05B 15/14

(57) ABSTRACT

An irrigation device with an indicator is provided that includes a sprinkler and an indicator. The sprinkler includes a cover defining an access port. The indicator is removably coupled to the sprinkler and includes a flange, a shaft, and threading. The shaft extends from the flange and the threading is disposed on the shaft and threadingly engages the access port of the cover.

### TECHNICAL FIELD

This application generally relates to providing changeable information on sprinklers and, more particularly, to indicator tags that are removably attached to sprinklers.

### BACKGROUND

Irrigation devices, such as sprinklers, are used in irrigation systems. Sprinklers discharge water to surrounding vegetation. There is a need to provide custom information on sprinklers. For example, many sprinklers discharge potable water. However, non-potable water is also used with sprinklers. Sources of non-potable water include reclaimed rainwater runoff or grey water from building systems.

Irrigation devices discharging non-potable water are often marked with some identifier that typically includes purple, which is generally known as an indicator for non-potable water. For many irrigation devices, this generally means that there is a separate version of the device that is marked with purple. However, this requires multiple versions of the same device (e.g., a version for use with potable water and a version for use with non-potable water). To avoid multiple versions of the same device, there is a need to easily customize the irrigation devices with the color purpose when discharging non-potable water. Such customized indication of the color purpose should also be removable, for example, to permit the color purpose to be changed when the water source is changed or the sprinkler is used in another irrigation system.

### BRIEF DESCRIPTION OF DRAWINGS

FIG. 1 is a perspective view of a sprinkler with an indicator separated from the sprinkler.

FIG. 2 is a perspective view of the sprinkler of FIG. 1 with the indicator installed with the sprinkler.

FIG. 3 is a cross-sectional view of the upper portion of the sprinkler and indicator taken along lines 3-3 of FIG. 2, with some internal components of the sprinkler removed for clarity.

FIG. 4 is a top perspective view of the indicator of FIG. 1.

FIG. 5 is a bottom perspective view of the indicator of FIG. 1.

FIG. 6 is a perspective view of a cover of the sprinkler of FIG. 1 including the indicator.

FIG. 7 is an exploded view of the cover and indicator of FIG. 6.

FIG. 8 is a bottom perspective view of the cover of FIG. 6 with the indicator in an unlocked position.

FIG. 9 is a bottom perspective view of the cover of FIG. 6 with the indicator in a locked position.

FIG. 10 is a perspective view of the indicator of FIG. 1 inserted into an upper portion of a sprinkler having a cover according to another embodiment.

FIG. 11 is a perspective view of the upper portion of the sprinkler of FIG. 10 with the indicator separated from the sprinkler.

### DETAILED DESCRIPTION

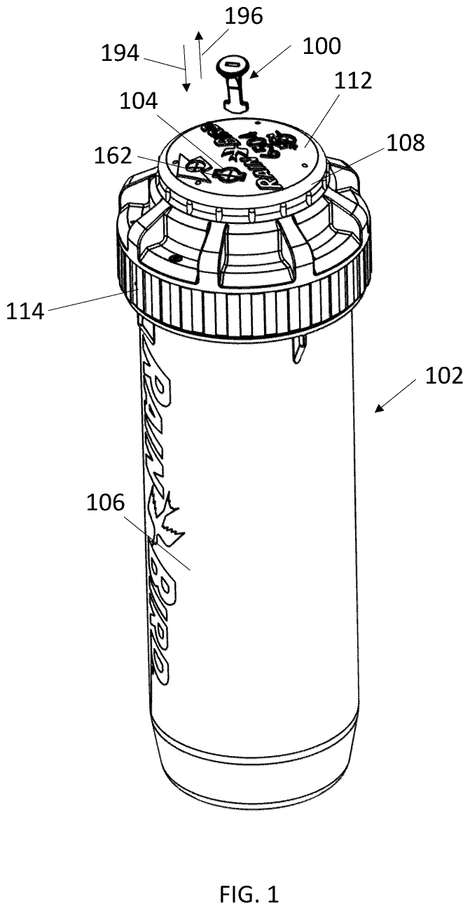

With respect to FIG. 1, an indicator such as indicator tag 100 is provided for use with an irrigation device such as a sprinkler 102. The indicator tag 100 can indicate the type of water being discharged from each sprinkler in the irrigation system. More specifically, the indicator tag 100 may include purple coloring to indicate that non-potable water is being emitted by the sprinkler 102. For instance, the indicator tag 100 may be molded of a purple-colored plastic. As another example, the indicator tag 100 may include tan coloring to indicate that water is emitted at high speeds, for example, for dust suppression. As another example, the indicator tag 100 may include green coloring to indicate that water discharge from the rotor of the sprinkler is capable of being shut off at the rotor. The indicator tag 100 may also provide identification information that indicates the location, zone, type, or other information about the sprinkler 102. The indicator tag 100 could be used to display advertising. While several example uses of the indicator tag 100 are provided, the indicator tag 100 has a wide range of applications and can be used to provide any type of information to a viewer.

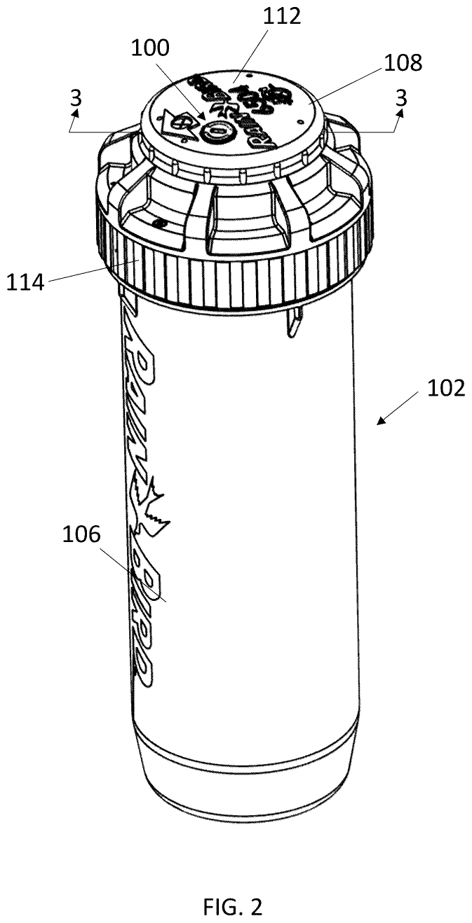

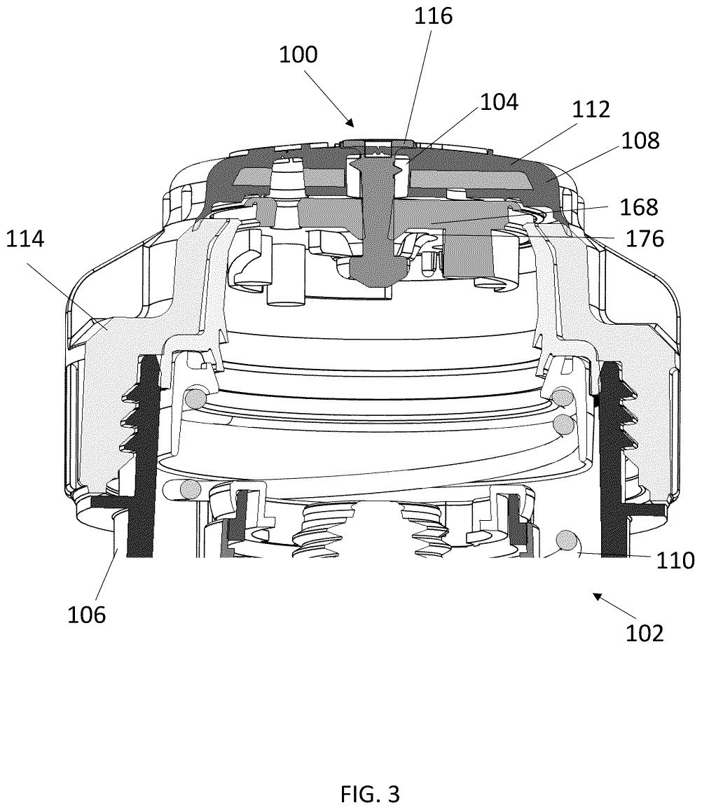

With respect to FIGS. 2 and 3, the indicator tag 100 is designed to be easily attached to and detached from a top of the sprinkler 102. For instance, the indicator tag 100 may be designed as a key that locks into a keyway 104 on the top of the sprinkler 102. The sprinkler 102 is a pop-up sprinkler that includes a stationary housing 106 and a riser 108 that reciprocates in and out of the housing 106. During an irrigation cycle, water pressure forces the riser 108 from the housing 106 against the bias of a spring 110. The spring 110 retracts the riser 108 into the housing 106 between irrigation cycles, for example, when the bias force of the spring 110 overcomes the water pressure on the riser 108. The riser 108 includes a riser cover 112 and the stationary housing 106 includes a housing cap 114. The riser cover 112 engages the housing cap 114 when the riser 108 is retracted into the housing 106. The riser cover 112 includes the keyway 104 and a tool may be used with the keyway 104 to aid in pulling the riser 108 from the housing 106 against the bias of the spring 110, for example, to service the sprinkler 102, such as changing a nozzle.

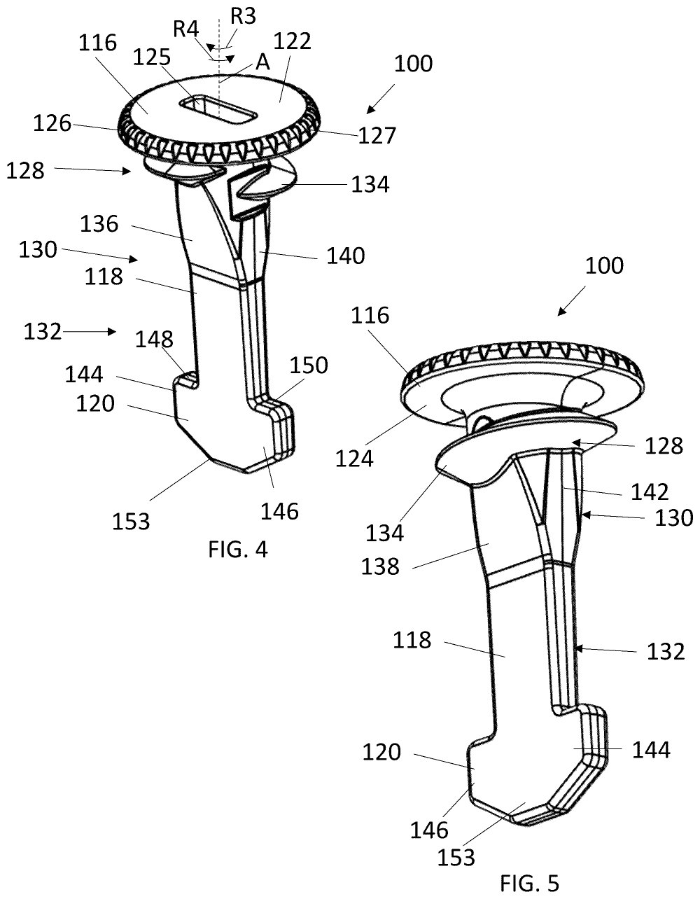

With respect to FIGS. 4 and 5, the indicator tag 100 includes a flange portion 116, a shaft 118, and a key 120. The indicator tag 100 may be formed of a rigid material such as a plastic (e.g., an engineering thermoplastic such as acetal). The flange portion 116 has an upper surface 122, a lower surface 124, and a side or perimeter surface 126. The upper surface 122 of the flange portion 116 remains visible from outside of the sprinkler 102 when the indicator tag 100 is attached to a sprinkler 102. For example, the upper surface 122 may be colored (e.g., painted purple, molded with a purple plastic, etc.). The upper surface 122 also may be printed or labeled with other information for a viewer.

The upper surface 122 defines a drive socket 125 that is shaped and sized to receive a drive head of a tool to secure the indicator tag 100 to and remove the indicator tag 100 from the sprinkler 102. In the form shown, the drive socket 125 is shaped to receive the drive head of a flathead screwdriver. The drive socket 125 is an elongated opening that extends parallel to the key 120, for example, to indicate the orientation of the key 120 when the key 120 is inserted into the sprinkler 102. In some forms, the flange portion 116 includes indicia to indicate an orientation of the key 120, for example, a protrusion on the side surface 126 and/or upper surface 122 of the flange portion 116 that indicates the orientation of the key 120. In other forms, the drive socket 125 may be configured to receive other types of drive heads, for example, Phillips or torx. The end portion of the drive tool may be inserted into the drive socket 125 to rotate the indicator about the axis A in directions R3 and R4 (see FIG. 4) to couple and uncouple the indicator tag 100 to the sprinkler 102 as discussed below.

The side surface 126 of the flange portion 116 may include grip elements 127, such as projections and/or dimples, extending around the circumference of the flange portion 116. The grip elements 127 may enhance a user's grip of the indicator tag 100 when inserting, rotating, or removing the indicator tag 100 from the sprinkler 102.

The shaft 118 extends from the lower surface 124 of the flange portion 116 to the key 120. The shaft 118 has an upper section 128, a tapered section 130, and a neck section 132. The upper section 128 includes threading 134 to aid in attaching and detaching the indicator tag 100 and sprinkler 102. The upper section 128 extends from the flange portion 116 toward the tapered section 130.

The tapered section 130 includes a first side 136, a second side 138, a third side 140, and a fourth side 142 that taper inward as they extend from the upper section 128 to the neck section 132. The first side 136 and the second side 138 of the tapered section 130 are located on opposite sides of the shaft 118 and taper towards one another as they extend toward the neck section 132. Similarly, the third side 140 and the fourth side 142 are located on opposite sides of the shaft 118 and taper towards one another as they extend towards the neck section 132. The tapered sides 136, 138, 140, 142 may each taper at a constant angle such that they are substantially flat.

At the neck section 132, the first side 136 and the second side 138 extend generally parallel to one another and generally perpendicular to the third side 140 and the fourth side 142, forming a generally rectangular cross-section. The neck section 132 extends from the tapered section 130 to the key 120. The key 120 includes a first bit 144 and a second bit 146. The first bit 144 and the second bit 146 extend radially outward from the neck section 132 in opposing directions such that the neck section 132 and the key 120 combine to form a T-shape. The first bit 144 has an upper surface 148 and the second bit 146 has an upper surface 150 that may engage a lock plate 168 of the sprinkler 102 to inhibit the indicator tag 100 from being unintentionally removed once installed as discussed below. The key 120 may include a tapered end portion 153 to guide the key 120 as the key 120 is inserted into the keyway 104.

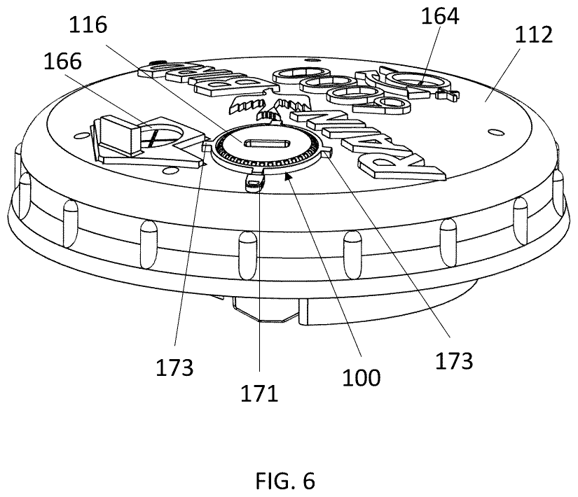

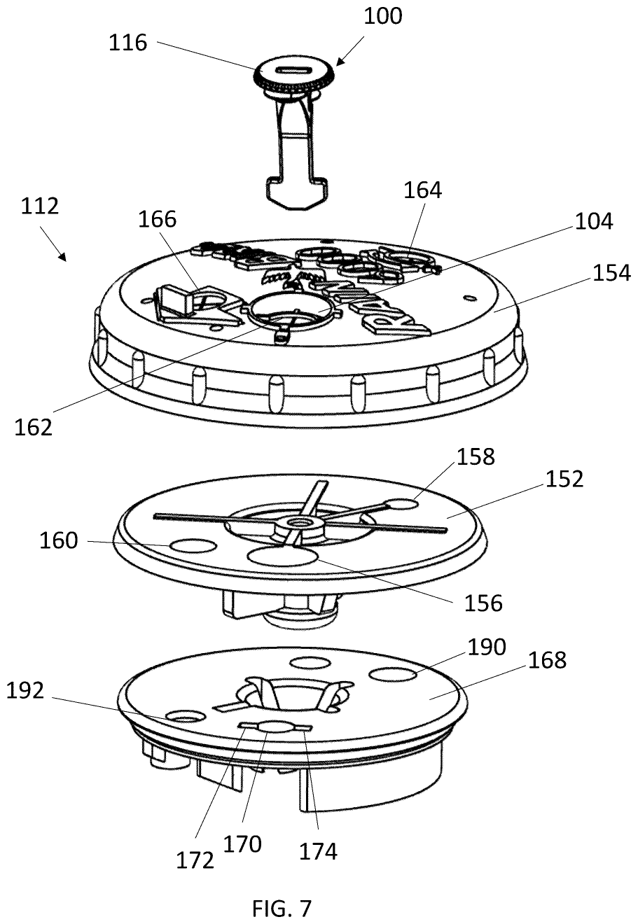

With respect to FIGS. 6 and 7, the indicator tag 100 may be attached to the riser cover 112 by inserting the key 120 of the indicator tag 100 into the keyway 104 through the riser cover 112 and the lock plate 168. The riser cover 112 may include a structural member 152 and a sealing layer 154 disposed over the structural member 152. The structural member 152 may be formed of a rigid material (e.g., a plastic) and have an opening 156 forming a portion of the keyway 104 through which the key 120 may be extended. The structural member 152 further includes openings 158, 160 through which the arc and radius of the sprinkler 102 may be adjusted.

The sealing layer 154 may be formed of an elastomeric material, for example, silicone and/or rubber (e.g., ethylene propylene diene monomer (EPDM) rubber in a polypropylene base). The sealing layer 154 may be overmolded on to the structural member 152. The sealing layer 154 includes the keyway 104 and sealing flaps 162 that cover the keyway 104 when the keyway 104 is not being used. The sealing flaps 162 may be elastically deflectable such that insertion of the indicator tag 100 into the keyway 104 deflects the sealing flaps 162 from their original, resting configurations to open the keyway 104 and permits insertion of the indicator tag 100. Upon removal of the indicator tag 100, the sealing flaps 162 return to their original, resting configuration to close the keyway 104 to inhibit fluid and debris from entering the sprinkler 102. The sealing layer 154 may also include openings 164, 166 corresponding to the openings 158, 160 of the structural member 152 for adjustment of the arc and radius of the sprinkler 102.

The threading 134 of the indicator tag 100 may engage the portion of the sealing layer 154 forming the keyway 104 to aid in securing the indicator tag 100 to the sprinkler 102. Specifically, the threading 134 may have a radial dimension that is larger than the opening of the keyway 104 such that the threading 134 forms an interference fit with the keyway 104 of the sealing layer 154 when the threading 134 is in the keyway 104. In other words, the maximum diameter of the threading 134 is greater than the minimum diameter of the keyway 104 such that the threading 134 compresses portions of the keyway 104 that the threading 145 is in contact with when the indicator tag 100 is threaded therein. The engagement of the rigid threading 134 with the compressible sealing layer 154 inhibits unintentional axial movement of the indicator tag 100 relative to the sprinkler 102.

The threading 134 of the indicator tag 100 also aids in attaching the indicator tag 100 to the sprinkler 102 and detaching the indicator tag 100 from the sprinkler 102. When the indicator tag 100 is being inserted into the keyway 104, the indicator tag 100 may be rotated about its axis (e.g., using the drive socket 125) in direction R3 which causes the threading 134 to engage the sealing layer 154 and urge the flange portion 116 of the indicator tag 100 toward the sprinkler 102. Rotation of the indicator tag 100 with the threading 134 during insertion thus permits the flange portion 116 to be drawn against the sealing layer 154, for example, to reduce the distance the indicator tag 100 protrudes from the riser cover 112 and/or to be drawn flush with the sealing layer 154.

When the indicator tag 100 is to be withdrawn from the keyway 104, the indicator tag 100 may be rotated about its axis (e.g., using the drive socket 125) in direction R4 which causes the threading 134 to engage the sealing layer 154 and urges the flange portion 116 of the indicator tag 100 away the riser cover 112. Rotation of the indicator tag 100 with the threading 134 during removal thus permits the flange portion 116 to move outward and protrude from the riser cover 112, for example, making the flange portion 116 easier to grasp by hand to remove the indicator tag 100 from the sprinkler 102.

With reference also to FIGS. 7-9, the sprinkler 102 includes the lock plate 168 which is attached to the structural member 152 and also used to secure the indicator tag 100 to the sprinkler 102. For example, the structural member 152 may be press fit into the lock plate 168. The lock plate 168 may be rigid, for example, formed of a plastic. The lock plate 168 includes a keyhole opening 170 including a first keyway 172 and a second keyway 174. The key 120 of the indicator tag 100 is sized and shaped so that the key 120 of the indicator tag 100 passes through the keyhole opening 170 of the lock plate 168 when properly aligned with the keyhole opening 170. More specifically, the first bit 144 and the second bit 146 of the key 120 are sized and shaped to pass through the respective first keyway 172 and the second keyway 174 of the lock plate 168.

Upon the first bit 144 and second bit 146 passing through the keyhole opening 170, the indicator tag 100 may be rotated as discussed above to misalign the key 120 of the indicator tag 100 and the keyhole opening 170 of the lock plate 168. When the key 120 and the keyhole opening 170 are misaligned, the lock plate 168 inhibits the key 120 from passing back through the keyhole opening 170 which inhibits the indicator tag 100 from being unintentionally removed from the sprinkler 102. For example, if an axial force is applied to the indicator tag 100 to withdraw the indicator tag 100 when the key 120 is misaligned with the keyhole opening 170, the upper surface 148 of the first bit 144 and upper surface 150 of the second bit 146 of the key 120 contact a lower surface 176 of the lock plate 168 which inhibits removal of the indicator tag 100.

The riser cover 112 may indicate the orientation of the keyhole opening 170 to aid the user in rotating the key 120 of the indicator tag 100 into or out of alignment with the keyhole opening 170 of the lock plate 168. For example, as shown in FIG. 6, the riser cover 112 may include indicia about the keyway 104 that indicates how to orient the key 120 to secure the indicator tag 100 to or remove the indicator tag 100 from the sprinkler 102. In the example shown, the riser cover 112 includes a lock symbol 171 that indicates the orientation of the indicator tag 100 when the indicator tag 100 is locked to the sprinkler 102 by the lock plate 168. For example, when the elongate drive socket 125 is aligned with or points toward the lock symbol 171, the key 120 is misaligned with the keyhole opening 170 and the indicator tag 100 is secured or locked to the sprinkler 102. The riser cover 112 may further include protrusions 173 that indicate when the key 120 is aligned with the keyhole opening 170 such that the lock plate 168 is not securing the indicator tag 100 to the sprinkler 102. The protrusions 173 may indicate how the indicator tag 100 should be oriented (e.g., 90 degrees from the lock orientation) to withdraw the key 120 from the lock plate 168.

In the embodiment shown, the shaft 118 of the indicator tag 100 supports the key 120 from the lower surface 176 of the lock plate 168 when the indicator tag 100 is fully installed. The threading 134 secures the indicator tag 100 to the sprinkler 102 with the engagement of the key 120 and the lock plate 168 being the secondary or failsafe means of securing the indicator tag 100 to the sprinkler 102. For example, the engagement of the key 120 with the lock plate 168 inhibits removal of the indicator tag 100 from the sprinkler 102 when the threading 134 of the indicator tag 100 is withdrawn from the riser cover 112 (either intentionally or unintentionally).

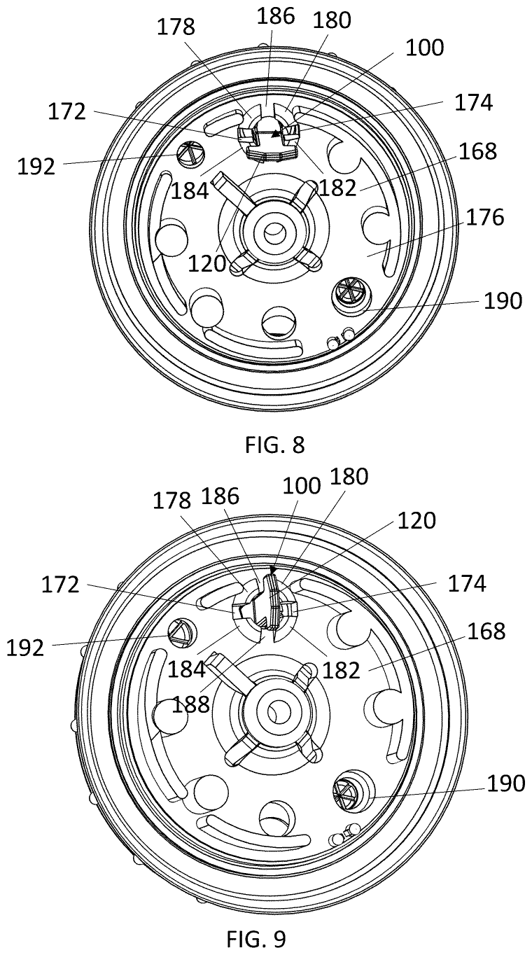

With reference to FIGS. 8 and 9, the lower surface 176 of the lock plate 168 is shown including a first projection 178, a second projection 180, a third projection 182, and a fourth projection 184. The projections 178, 180, 182, 184 are positioned about the keyhole opening 170 of the lock plate 168. The projections 178, 180, 182, 184 may each be partially annular projections. The first keyway 172 extends between the first projection 178 and the fourth projection 184, and the second keyway 174 extends between the second projection 180 and third projection 182. The lock plate 168 includes a locking recess such as a first keyseat 186 between the first projection 178 and the second projection 180. The first keyseat 186 may be a recess or groove extending between the first and second projections 178, 180. The lock plate 168 further includes a locking recess such as a second keyseat 188 between the third projection 182 and the fourth projection 184. The second keyseat 188 may be a recess or groove extending between the third and fourth projections 182, 184.

When the key 120 is misaligned with the keyhole opening 170, the first bit 144 and second bit 146 of the key 120 may contact the first keyseat 186, the second keyseat 188, and/or projections 178, 180, 182, 184 which inhibit removal of the key 120 from the keyhole opening 170. When the first bit 144 and second bit 146 of the key 120 are positioned in the first keyseat 186 and the second keyseat 188, the projections 178, 180, 182, 184 may inhibit rotation of the indicator tag 100 to keep the indicator tag 100 secured to the sprinkler 102.

The lock plate 168 has a second opening 190 and a third opening 192 that correspond to and align with the openings 158, 160 of the structural member 152 for adjustment of the arc and radius of the sprinkler 102.

To attach the indicator tag 100, the key 120 of the indicator tag 100 is aligned with the keyway 104 of the sprinkler 102. The indicator tag 100 is moved in direction 194 (see FIG. 1) to insert the key 120 into the keyway 104. The indicator tag 100 may be advanced in direction 194 until the key 120 passes through the keyhole opening 170 of the lock plate 168. The indicator tag 100 may be rotated in direction R3 (see FIG. 4), causing the threading 134 to engage the sealing layer 154 of the riser cover 112 to thread the indicator tag 100 to the sprinkler 102 to secure the indicator tag 100 thereto. The indicator tag 100 may be rotated by inserting a tool (e.g., a flathead screwdriver) into the drive socket 125 and rotating the tool. Threading the indicator tag 100 to the sprinkler 102 also moves the indicator tag 100 in direction 194. The indicator tag 100 may be threaded until the flange portion 116 contacts the riser cover 112. The indicator tag 100 may be rotated to misalign the key 120 of the indicator tag 100 from the keyhole opening 170 of the lock plate 168 such that the lock plate 168 inhibits the indicator tag 100 from being removed.

To detach the indicator tag 100, the indicator tag 100 may be rotated in direction R4 (see FIG. 4) which causes the threading 134 to engage the sealing layer 154 of the riser cover 112 and move the indicator tag 100 in direction 196 outward from the sprinkler 102. Movement in direction 196 as the indicator tag 100 is rotated causes the flange portion 116 of the indicator tag 100 to move away from the riser cover 112 which makes it easier to grasp the indicator tag 100 for removal from the sprinkler 102. The indicator tag 100 may be rotated in direction R4 until the threading 134 no longer engages the sealing layer 154 and the key 120 is aligned with the keyhole opening 170. The indicator tag 100 may be moved axially in direction 196 to withdraw the key 120 of the indicator tag 100 from the keyway 104.

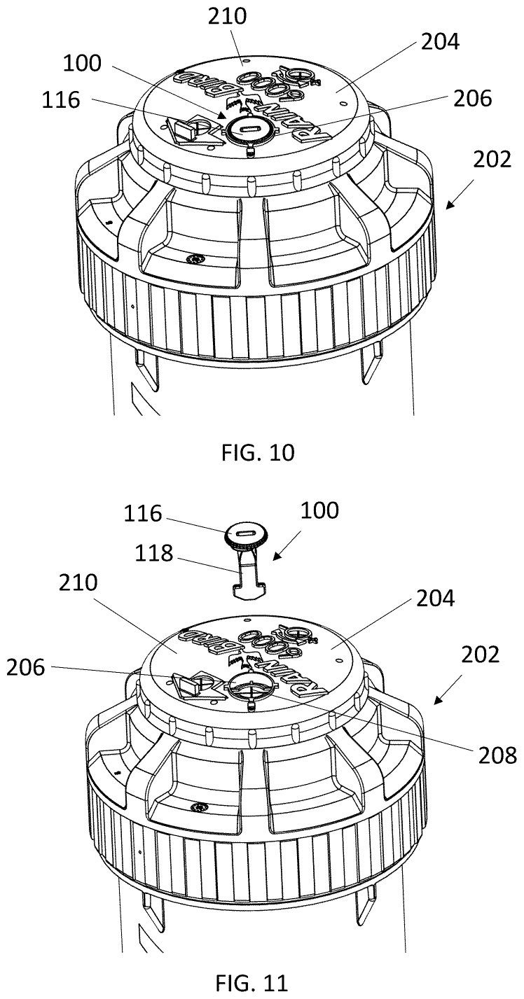

With respect to FIGS. 10 and 11, a sprinkler 202 is provided according to another embodiment. The sprinkler 202 is like the sprinkler 102 discussed above but has a different riser cover 204. The riser cover 204 has a keyway 206 into which the indicator tag 100 may be inserted as discussed above. The riser cover 204 has sealing flaps 208 that close the keyway 206 when the indicator tag 100 is withdrawn from the sprinkler 202 and that open when the shaft 118 of the indicator tag 100 is inserted therein. In the riser cover 204 of the sprinkler 202, the sealing flaps 208 are recessed from a top surface 210 of the riser cover 204 and the keyway 206 is sized to receive the flange portion 116 of the indicator tag 100. This permits the indicator tag 100 to be inserted further into the riser cover 204, for example, until the upper surface 122 of the indicator tag 100 is substantially flush with the top surface of the riser cover 204. The threading 134 of the indicator tag 100 permits the indicator tag 100 to easily be removed after installation, because the rotation of the indicator tag 100 in direction R4 causes the flange portion 116 to move away from the top surface of the riser cover 204.

The matter set forth in the foregoing description and accompanying drawings is offered by way of illustration only and not as a limitation. While embodiments are shown and described, it will be apparent to those skilled in the art that changes and modifications may be made without departing from the broader aspects of the technological contribution. The actual scope of the protection sought is intended to be defined in the following claims.

1. An irrigation device with an indicator comprising:
a sprinkler including a cover defining an access port; and
an indicator removably coupled to the sprinkler at the access port, the indicator including:
a flange;
a shaft extending from the flange; and
threading disposed on the shaft and threadingly engaging the cover at the access port.

2. The irrigation device of claim 1 wherein the cover includes an elastomeric layer and the threading engaging the elastomeric layer.

3. The irrigation device of claim 1 wherein the indicator is made of plastic.

4. The irrigation device of claim 1 wherein the sprinkler further includes a locking plate defining a first keyway aligned with the access port to receive a portion of the indicator.

5. The irrigation device of claim 4 wherein the indicator further includes a key supported by the shaft, the key including a first bit extending radially outward from the shaft, the first bit of the key shaped for insertion through the access port of the cover and the first keyway of the locking plate, and the indicator rotatable relative to the locking plate to misalign the first bit and the first keyway to inhibit removal of the indicator from the sprinkler.

6. The irrigation device of claim 5 wherein the locking plate includes a second keyway, the key includes a second bit extending radially outward from the shaft and opposite the first bit, the second bit of the key being shaped to be inserted through the access port of the cover and the second keyway of the locking plate, and the indicator rotatable relative to the locking plate to misalign the second bit and the second keyway to inhibit removal of the indicator from the sprinkler.

7. The irrigation device of claim 1 wherein the sprinkler includes a housing and a riser movable relative to the housing, and the riser including the cover.

8. The irrigation device of claim 1 wherein the flange displays information.

9. The irrigation device of claim 1 wherein at least the flange defines a socket.

10. The irrigation device of claim 9 wherein the socket is shaped to receive a driver portion of a tool.

11. The irrigation device of claim 1 wherein the cover includes at least one deflectable flap at the access port positioned to engage the threading.

12. A sprinkler indicator comprising:
a flange;
a shaft extending from the flange to be inserted into a sprinkler; and
threading disposed on the shaft to threadingly engage the sprinkler to removably couple the sprinkler indicator to the sprinkler.

13. The sprinkler indicator of claim 12 wherein the flange includes identifying information.

14. The sprinkler indicator of claim 13 wherein the identifying information includes coloring coordinated with a predetermined use or feature of a sprinkler.

15. The sprinkler indicator of claim 12 further comprises a driver located at least in part at the flange to rotate the sprinkler indicator.

16. The sprinkler indicator of claim 12 further comprises a key supported by the shaft and including at least a first bit extending radially outward from the shaft.

17. The sprinkler indicator of claim 16 wherein the shaft includes a tapered portion tapering inwardly as the shaft extends from the flange toward the key.

18. The sprinkler indicator of claim 12 wherein the flange includes a perimeter with an inconsistent profile for gripping.

19. The sprinkler indicator of claim 18 wherein the inconsistent profile includes protrusions and/or recesses.

20. The sprinkler indicator of claim 12 wherein the flange defines a drive socket shaped to receive a complementary drive portion of a tool.

21. The sprinkler indicator of claim 20 wherein the drive socket defines an elongated opening.

22. The sprinkler indicator of claim 12 further comprises a key having a first bit and a second bit, and the first bit and the second bit extend radially outward from the shaft in different directions.

23. The sprinkler indicator of claim 12 wherein the flange includes advertising information.

24. A method of installing an indicator to an irrigation device, the method comprising:
inserting at least a portion of an indicator into an access port of a cover of a sprinkler until threading of a shaft of the indicator extends into the access port; and
rotating the indicator in a first direction to cause the threading to engage the cover to removably secure the indicator to the cover.

25. The method of claim 24 further comprises rotating the indicator in a second direction opposite the first direction to cause the threading to engage the cover to move the indicator outward from the sprinkler.

26. The method of claim 24 further comprises aligning a key of the indicator with the access port of the cover before inserting.

27. The method of claim 24 wherein inserting at least a portion of an indicator includes inserting the at least a portion of the indicator to pass a first bit of a key of the indicator through a first keyway of the sprinkler.

28. The method of claim 27 wherein rotating the indicator causes the first bit to be misaligned with the first keyway.

29. The method of claim 24 further comprises inserting a driver portion of a tool into a socket of the indicator and rotating the indicator includes rotating the indicator with the tool.
